(19) United States
(12) Patent Application Publication
(10) Pub. No.: US 2017/0120535 A1
(43) Pub. Date: May 4, 2017

(54) Actuatable Assemblies Fabricatable by Deposition of Solidifying and Non-Solidifying Materials

(71) Applicant: Massachusetts Institute of Technology, Cambridge, MA (US)

(72) Inventors: Robert Bruce MacCurdy, Belchertown, MA (US); Daniela Rus, Weston, MA (US)

(21) Appl. No.: 15/342,987

(22) Filed: Nov. 3, 2016

Related U.S. Application Data
(60) Provisional application No. 62/250,006, filed on Nov. 3, 2015.

(51) Int. Cl. B29C 67/00; B33Y 50/02; B33Y 80/00; B33Y 10/00

(52) U.S. Cl. CPC B29C 67/0092; B29C 67/007; B29C 67/0088; B33Y 10/00; B33Y 50/02; B33Y 80/00; B29K 2105/0058

(57) ABSTRACT

Actuatable assemblies fabricated by deposition of solidifying and non-solidifying materials are described herein. The actuable assemblies can be formed by co-deposition of a solidifying material and a non-solidifying material.

### RELATED APPLICATION

This application claims the benefit of U.S. Provisional Application No. 62/250,006, filed on Nov. 3, 2015. The entire teachings of the above application are incorporated herein by reference.

### GOVERNMENT SUPPORT

This invention was made with Government support under Grant Nos. U.S. Pat. No. 1,226,883 and CCF-1138967 awarded by the National Science Foundation. The Government has certain rights in the invention.

### BACKGROUND

Building robots has historically been a time-consuming process. Constrained by available fabrication techniques, conventional robotic design practice requires sequential assembly from many discrete parts, with long concomitant assembly times. Mass-production achieves efficiency gains through optimizing each assembly step, but optimization requires that the design be fixed; even small changes become difficult and costly. Additionally, because many robots are unique or application-specific, relatively few opportunities to automate their assembly exist. This situation is worsened by inevitable design-fabricate-test-redesign iterations.

Conventional fabrication methods employ predefined tooling to cut, extrude, stamp, cast or roll materials into desired geometries with high throughput and at low cost. These methods can be thought of as a continuous trade-off between versatility and throughput. For example, a stamping press with a die customized for a particular part can rapidly produce many identical copies of that part, but slight design modifications to the part require costly and time-consuming changes to the die. In contrast, a computer numerical control (CNC) milling machine with interchangeable tools can easily accommodate design changes, but is slower than stamping, is constrained by the reachable space of its tooling, and cannot readily create parts with heterogeneous structure. Additive manufacturing tools (“3D printers”), which build parts by selectively placing and fusing the part's constitutive materials, exist at the extreme of this continuum. This process is relatively slow, but enormously versatile.

### SUMMARY OF THE INVENTION

Described herein is a method of forming a structure. The method includes depositing layers of a solidifying material and a non-solidifying material. The depositing forms a volume defined by the solidifying material and contains the non-solidifying material within the volume. The depositing is capable of depositing the solidifying and non-solidifying materials at substantially each layer while forming the volume. The method further includes encapsulating the non-solidifying material within the volume by depositing the solidifying material in a manner that forms a continuous, interior surface of the solidifying material to seal the volume. The method can further include solidifying the solidifying material, thereby forming the structure.

The non-solidifying material can be deposited as a liquid. Depositing layers can include depositing a support material at given locations. The method can also include removing the support material during or after the solidifying material solidifies. The support material can be removed during the solidifying by removing fluid “dams” or “plugs” during fabrication, draining out fluid that had previously acted as support material.

The support material can be deposited to prevent flow of the non-solidifying material. In some embodiments, the interior surface is seamless. One or more of the solidifying material, non-solidifying material, and support material can be an additive manufacturing material, such as additive manufacturing material used in 3D printing processes.

Depositing the solidifying material can include forming a deformable structure, defined by the solidifying material, configured to deform at least a portion of the volume in response to a mechanical force. The structure can have a plurality of deformable pleats. In some instances, the pleats can have varying cross-sectional thickness. The structure can have enmeshed counter-rotating teeth.

In some instances, the depositing is performed by a print head, which can include a roller. The method can further include applying the roller to a surface of the solidifying material to smooth the surface of the solidifying material. The method can also include raising the roller above a portion of a surface of the non-solidifying material so that the roller does not remove the portion of the surface of the non-solidifying material.

Depositing layers can be performed by first depositing the solidifying material and then depositing the non-solidifying material. Solidifying can include exposing the solidifying material to light or cooling the solidifying material. Depositing layers can include forming a channel in at least a portion of the volume, the non-solidifying material filling at least a portion of the channel. The channel can be oriented horizontal, vertical, or any angle therebetween, relative to the layers. The solidifying material can be deposited to form a perimeter of the channel, and the non-solidifying material can be deposited in a manner that underfills the channel while forming the channel. The method can also include filling an underfilled channel with the non-solidifying material prior to encapsulating the non-solidifying material. The channel can have a varying cross-sectional area along a portion of the channel.

In some instances, the depositing can include depositing a second solidifying material. The solidifying materials can have different elastic moduli after solidifying.

Also described herein is a deformable structure. The deformable structure defines a volume, the structure comprising a continuous interior surface of solidified material that encapsulates a non-solidified material within the volume, the structure being deformable in response to a mechanical force. Mechanical properties of the structure can differ at different locations of the structure. The inner surface of the structure can be seamless. One or more of the solidifying material and the non-solidifying material can be additive manufacturing materials.

In some instances, deformable structure can include an internal channel having the non-solidified material therein. The structure can define an exterior surface, wherein at least a portion of the exterior and interior surfaces are deformable, and wherein applying a force to the deformable exterior surface causes the interior surface to deform and, in turn, causes the volume to deform and force an amount of the non-solidified material to flow through the channel. The deformable exterior and interior surfaces can define a plurality of deformable pleats in fluid communication with the channel. Deformation of the pleats can cause flow of the non-solidified material to flow along the channel.

In some instances, the deformable structure can include a second solidified material. The solidified materials can have different elastic moduli.

The methods described herein enable co-deposition of solidifying and non-solidifying materials, thereby resulting in a structure with both solidified and non-solidified materials. Typically, the non-solidified material is a liquid, but it can also be a gel.

Embodiments disclosed herein extend the capabilities of multi-material 3D printing by incorporating a material that does not solidify into a material palette, thereby permitting manufacture of structures that allow force-transfer throughout an assembly via hydraulic pressure.

Embodiments of the method described herein provide a number of advantages. Since 3D printers can produce arbitrary geometries with multiple materials simultaneously, individual components can be co-fabricated in-situ, eliminating most or all assembly steps. This transforms the design space: complexity becomes free, once the 3D printer has been purchased, because incremental increases in design complexity do not require increases in fabrication complexity. Similarly, 3D printing makes the incremental cost of variety very low, allowing components to be diversified and specialized in an individual robot or across a suite of robots. Additionally, 3D printing reduces fabrication lead-times to zero, removes requirements for operator skill, and frees designers from most constraints imposed by the reachable space of the machine tool.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a mechanical schematic diagram illustrating fabrication of printable hydraulics via inkjet according to an embodiment of the present invention.

FIG. 2 is photograph of a 3D-printed bellows produced via inkjet in a single print produced by co-deposition of liquids and solids, allowing fine internal channels to be fabricated and pre-filled, where the bellows is ready to use when removed from the printer.

FIG. 3 is a mechanical schematic diagram of a unit-section of the printed bellows of FIG. 2, dimensions in mm, where additional displacement can be achieved by stacking multiple sections together.

FIG. 4 is a graphical image of an example of a Von-Mises-stress-analysis result of a cross section of one bellows that illustrates finite element analysis (FEA) that allows for design optimization via homogenization to mitigate stress concentrations.

FIG. 5 is graph of load (N) vs. compression (mm) from bellows compression experiments with no applied fluid pressure (port is open to the atmosphere) compared to finite element analysis experiments using four levels of Young's modulus values. These tests reveal the intrinsic stiffness of this particular actuator design.

FIG. 6 is a graph of measured force (N) vs. applied gauge pressure (Pa) vs. applied pressure for the example bellows actuator shown in FIG. 2.

FIG. 7 is a photograph of a hexapod robot with all mechanical parts fabricated in a single printing operation according to an embodiment of the present invention.

FIGS. 8A-B are a schematic (FIG. 8A) and photograph (FIG. 8B) of a 3D-printed gear pump realized via co-fabrication of solidifying and nonsolidifying (e.g., liquids) in a single printing operation according to an embodiment of the present invention. Gears 220 are captive and fabricated in-place using liquid as support during the fabrication process. The gears spin freely when powered by an added electrical motor (not shown). In FIG. 8B, the support material 210, pump housing 230, and gears 220 are shown. Note the cylindrical support pillars (see Table I).

FIG. 9 is a graph of differential pressure output (Pa) vs. Flow rate (ml/min) for a variety of applied power (W) for the 3D-printed gear pump.

FIG. 10 is a photograph of a 3D-printed soft gripper fabricated via inkjet deposition of a liquid photopolymer, which becomes a soft elastomer (28 Shore A) upon curing by exposure to ultraviolet (UV) light, and polyethylene glycol (e.g., a non-solidifying, non-curing liquid).

FIG. 11 is a schematic showing a cross-section of a 3D-print pattern for a bellows portion of a hexapod robot according to an embodiment of the present invention.

FIG. 12 is a schematic showing a cross-section of a 3D-print pattern for a soft gripper according to an embodiment of the present invention.

FIGS. 13A-B are schematics showing a perspective view (FIG. 13A) and a cross-section (FIG. 13B) of a 3D-print pattern for a gear pump according to an embodiment of the present invention.

### DETAILED DESCRIPTION OF THE INVENTION

A description of example embodiments of the invention follows.

Multi-material additive manufacturing techniques offer a compelling alternative fabrication approach compared to conventional fabrication techniques, allowing materials with diverse mechanical properties to be placed at arbitrary locations within a structure, and enabling complex multi-part design iterations to be rapidly fabricated with trivial effort.

3D printers have been demonstrated with a variety of model materials, ranging from ice to nylon to cookie dough. However, non-solidifying materials have not been widely used as either model or support material. The role of support material in 3D printers is to provide a platform for overhanging geometries on subsequent layers during bottom-up, layer-by-layer fabrication; weak solidifying materials that can be washed away or dissolved are typically used as support. A related approach uses wax as a support material; the wax hardens soon after deposition and is melted away in a post-processing purging step. The use of solidifying support material imposes constraints on the aspect ratio of embedded channels and the channel termination, because long narrow channels, closed channels, or channels with large volumes at the end are difficult or impossible to purge. For this reason, support materials that solidify are viable when printing individual components that will be cleaned and then manually assembled, but not for fabricating complete hydraulically actuated assemblies. The traditional solution is to add multiple purge ports that must be manually sealed in a time-consuming post-processing step. For this reason most 3D printed fluidic (and microfluidic) applications are either planar, which allows clean-out from above before a top-plate is added, or utilize small, easily cleaned sections requiring assembly.

Recently, 3D printing has been used to produce kinematic chains for actuated models via interconnected gears and linkages. While this is an enabling capability for roboticists, printed gears and linkages currently suffer from high friction (since printed bearings have not been demonstrated), low-strength, low-resolution (which limits the number of force-transmitting elements that can be placed in a given volume) and large backlash. Printed pneumatic systems overcome some of these challenges via bellows. However, robots using these structures have thus-far required multiple assembly steps, use support material that must be manually purged, and employ purge holes that must be sealed before inflating with the working gas. Individual hydraulic components have also been fabricated with 3D printers based on laser sintering (or melting), which utilize un-fused model material as support. This fine powder can be washed away in a cleaning procedure analogous to removing wax support, with similar post-processing requirements. Other 3D-printed manipulators employ cable-driven linkages, which require multiple manual assembly steps.

### Overview of Printable Hydraulics Fabrication

Multi-material deposition is used to fabricate solidifying and non-solidifying regions simultaneously, which subsequently become solid and non-solid regions within a structure.

As used herein, solidifying materials refer to materials that solidify in accordance with performing the methods described herein. For example, solidifying materials include materials that solidify due to a curing process, whereby the solidifying material polymerizes to yield a solid material. In some embodiments, the solidifying material polymerizes upon exposure to UV light. Such solidifying materials are readily available for sale from Stratasys Ltd., Eden Prairie, Minn., USA, for use in 3D printers sold by Stratasys. Other solidifying materials include plastics that can be heated to a liquid phase and that change to a solid upon cooling to room temperature.

As used herein, non-solidifying materials refer to materials that do not solidify at room temperature. Examples include polyethylene glycol, water, and many alcohols. While these liquids may freeze if cooled to a low enough temperature, they are considered non-solidifying within the normal operating temperature range for 3D printers. For example, 3D printing is typically conducted at room temperature, while polyethylene glycol, water, and many alcohols freeze at temperatures below room temperature, and thus they are non-solidifying under ordinary use conditions.

The multi-material deposition described herein is similar to inkjet printing, except that the print head deposits drops of material that form a three-dimensional structure rather than drops of ink. An example of an inkjet-style printer used for 3D printing is described in U.S. Pat. No. 7,225,045. Deposition of materials that solidify with varying stiffness allows certain portions of the resulting structure to be more flexible, enabling prescribed strain in response to applied fluidic pressure. Supporting layers can be provided either via removable curing support material or by non-curing liquid.

### Printable Hydraulic Process

Printed hydraulic parts are functional, fluidically-actuated structures that employ a non-solidifying material, typically a liquid, as an active, permanent, force-transmitting component. These parts, including the non-solidifying materials (e.g., liquids), are printed in a single printing operation, thereby requiring no assembly or minimal assembly (e.g., no post-solidified assembly).

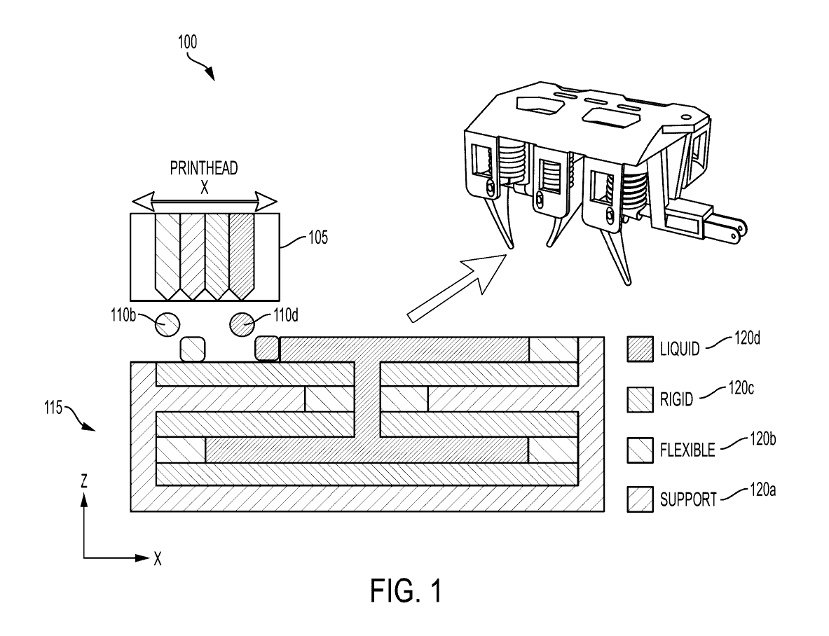

FIG. 1 is a mechanical schematic diagram illustrating the printed hydraulics process 100 applied to a four-material inkjet 3D printer. Such a printer can simultaneously fabricate solid and liquid regions within a structure. A print-head 105 deposits individual droplets 110b, 110d of material in a layer-by-layer build process to form a structure 115 defined by multiple materials, including a support material 120a, flexible material 120b, rigid material 120c, and non-solidifying (e.g., liquid) material 120d. Here, the flexible material 120b and rigid material 120c are different types of solidifying materials, such as solidifying materials that have different elastic moduli after being solidified. A 3D printer deposits solidifying and non-solidifying (e.g., liquid) regions within a printed assembly. Prescribed strain in response to applied fluidic pressure can be achieved by printing with solids that have different elastic moduli or by designing appropriate model geometries. Supporting layers can be provided via removable support material or liquid. As an example, a hexapod robot can be printed in one printing operation, requiring only a single added DC motor. The motor causes deformation of printed bellows, which causes the non-solidified material to flow through channels to cause a resulting deformation of the printed bellows, thereby causing the legs to move.

Each successive layer is deposited on the previous layer and supports subsequent layers. Individual layers contain one or more material types, depending on the part geometry. Small droplet sizes (approximately 20-30 μm diameter is typical) enable deposition of solidifying and non-solidifying materials in finely spaced patterns. Solids of varying stiffness can also be created by interdigitated deposition of two or more solidifying materials. Forming solids of varying stiffness permits the formation of structures having prescribed strain in response to an applied fluidic pressure. Supporting layers can be provided either by a removable curing support material, which can also be deposited by the 3D printer, or by a non-curing liquid.

While a particular embodiment described herein pertains to inkjet deposition, the printable hydraulics approach can also be applied to other 3D printing methods. For example, stereolithography uses focused light to solidify photopolymers selectively in a layer-by-layer process. Rather than allowing the uncured material to drain out of the model, certain regions of liquid may be permanently enclosed. Similarly, 3D printers based on fused deposition molding (FDM) are now capable of depositing a variety of materials, including liquids, through interchangeable toolheads. A dedicated nozzle with liquid can allow these multi-material FDM printers to create and then fill enclosed volumes with working fluid.

Printable hydraulics offers several benefits to designers of robots. First, additional assembly is not required because the force-transmitting fluid is deposited at the same time as the robot's solid body. This benefit enables complex actuated structures that would be inconvenient or impossible to assemble manually. Second, printed hydraulics enables complex, intricate geometries that are infeasible with other 3D printing methods. For example, removing support material from tortuous capillary-like structures is often impossible. This is the case even with wax support when the aspect ratio of the channels is high, when it is not possible to include purging ports in the design, or when sealing these purging ports would impose onerous labor or design constraints. Third, precise geometric control allows the creation of channels with differing resistances to fluid flow that can selectively distribute dynamic hydraulic flows to regions of the assembly. The cross-section of the channels impacts the pressure front of the traveling pressure wave of liquid moving through a channel. Therefore, controlling the cross-sectional design (e.g., geometry and cross-sectional area) permits the design of unique hydraulic flow patterns. In addition, the composition of the solidified region can be further varied by depositing two or more solidifying materials that are interdigitated with each other to form a composite material having properties resulting from the two solidifying materials. As a results, graded elasticity can be achieved by forming a solidified region from two or more interdigitated materials and by varying the geometry of the solidified region. Used together, these techniques can enable prescribed movements in response to changes in pressure from a single source, allowing under-actuated control through model geometry. Fourth, the use of a substantially incompressible working fluid (e.g., most liquids) simplifies the control of complex fluid-actuated assemblies, relative to systems based on pneumatics. Fifth, there is no need to purge air bubbles because the solidified and non-solidified regions are fabricated together. Sixth, non-curing liquids are useful as an easily-removed support structure for subsequent layers; this approach is widely used in the examples we show. Seventh, compared to previous work employing kinematic linkages or gears in active 3D printed assemblies, printed hydraulics offers low-friction, low-backlash, high force-transmission elements.

### Architecting a 3D Printer for Hydraulics

The 3D printer employed herein, a STRATASYS OBJET260 CONNEX (Stratasys Ltd., Eden Prairie, Minn., USA), uses a plurality of print heads to codeposit, in a single printing operation, up to three different photopolymers and achieves finished-part resolutions better than 100 μm. The print heads deposit the photopolymers similarly to an inkjet print head. The OBJET260 uses eight print heads with linear arrays of nozzle to deposit resins (e.g., solidifying materials) onto the build surface. These resins rapidly cure when exposed to the high-intensity UV light source mounted on the print head. Three-dimensional models are broken up into thin slices, and printed from the bottom-up, layer by layer. Four print heads deposit removable support material, and four print heads deposit one or two model materials (e.g., solidifying materials). The removable support material is typically a soft, UV-cured solid. Resins for the printer are supplied in plastic cartridges and these cartridges are labeled with an RFID chip, used by the printer to identify the material.

### Printer Configuration

STRATASYS sells a non-photopolymerizing material, composed primarily of polyethylene glycol according to a supplied material safety datasheet (MSDS), as a “model cleaning fluid” (e.g., intended for use in cleaning the tubes, lines, and components inside the 3D printer. This material is appropriate as a working hydraulic fluid because it is designed to be jetted by the printheads, yet does not cure when exposed to UV light. In other words, the non-photopolymerizing material is non-solidifying. The printer will not accept cleaning fluid as a working material, but the system can be spoofed by replacing the RFID chip in the cleaning fluid cartridge with one from a different model material. For example, an RFID chip from the TANGO BLACK PLUS material can be used. This choice matters because the printer's drive software, OBJET STUDIO, automatically inserts several supporting layers underneath the model as it is being printed. OBJET STUDIO will attempt to print the very first layers, the “carpet,” with a hard material, if available. Choosing a softer material like Tango Black Plus as the spoofed type avoids depositing two layers of non-curing liquid at the bottom of the part.

The OBJET260 has two model material slots, labeled “Model 1” and “Model 2,” which are slots for solidifying materials. OBJET STUDIO automatically intersperses model material within the automatically generated support material in order to stiffen the supporting structure; this inserted material is known as the “grid.” Inserting the liquid cartridge, which the printer recognizes as TANGO BLACK PLUS, into model slot two avoids printing liquid material as the grid.

Inkjet printers deposit droplets of ink by applying a pulse of voltage to piezoelectric actuators located at each nozzle; the rapidly expanding piezo material displaces ink, forcing it through the nozzle. The nozzles' driving waveforms are calibrated to the ink rheology. In the field of 3D printing, the printed material is often referred to as “ink.” Although the inkjet nozzles can very precisely deposit droplets of ink, the precise height of each droplet is difficult to control. Even very small deviations in droplet volume could accumulate over many layers, resulting in printed layer heights substantially different from the CAD model. The OBJET printers appear to address this issue by slightly over-driving the ink, and removing excess model material with a rotating drum, the “roller”, to provide a uniform layer height. As a side-effect, however, the roller tends to push uncured liquid in the direction of the head's travel, forcing liquid to move out of its intended region, contaminating adjacent curing layers.

OBJET STUDIO does not expose the nozzle drive waveform to the user; however, it does allow the nozzle drive voltage to be calibrated—per head. When the cartridge containing liquid is loaded into model slot two, the liquid is routed to model heads M2 and M3. A head drive voltage of 19.4V was experimentally determined to reduce the amount of liquid ejected from the nozzles. Reducing the drive voltage of the liquid print-heads intentionally under-jets that material, resulting in less liquid in the model and lowering the level of liquid layers, relative to solid layers. In other words, this technique can be used to underfill a nonsolidifying material relative to the solidifying material.

Another technique is to deposit some of the solidifying material first, and then to deposit some of the non-solidifying material. Sequencing the deposition of solidifying and non-solidifying materials in this way allows the solidifying material to solidify in the absence of the non-solidifying material, which can improve the build quality by avoiding intermingling of the solidifying and nonsolidifying materials when each are in a liquid state.

One of skill in the art will appreciate that the structures and embodiments described herein are made by modifying existing 3D printers, though specially-designed printers that do not require such modification are preferable. The approaches described in this section are imperfect compromises, and impose design constraints, described in section below regarding design rules.

### Design Rules

Designing solid and liquid printed geometries follows many of the same operations as a conventional CAD/3D-printing work-flow. The liquid parts, like the solid parts, must be specified via a stereolithography file (.STL file), and a model material in the printer is assigned to that file. In the case of the printed liquid, the spoofed material type (e.g., TANGO BLACK PLUS) should be assigned to the file specifying the liquid geometry. Note that all references to direction are with respect to the printer's coordinate system, rather than the coordinate system of the resulting structure.

The OBJET260 datasheet specifies an X/Y accuracy in the range of 20-85 μm, and a Z accuracy of 30 μm when printing with multiple materials. However, the observed resolution at liquid-solid interfaces when printing liquids is substantially coarser. The achievable print resolution when printing with liquids was characterized by creating various test geometries and printing many iterations of these geometries with different orientations on the build tray. These tests revealed the primary challenge when printing with liquids: non-solidifying materials are moved by the roller and swept onto adjacent solidifying material. The presence of the non-curing (non-solidifying) material inhibits the bonding between droplets of solidifying material within the current layer, and between subsequent layers. This effect is most pronounced at solid/liquid boundaries perpendicular to the print-head's direction of travel (interfaces parallel to the Y axis), and is exacerbated by long unbroken segments of liquid. For this reason, it is advantageous to minimize unbroken stretches of liquid in any slice of the model. This can be accomplished either by adding portions of solidifying material to the model or by creating voids in the model which will be filled with removable support material by the printer driver software.

Since the liquid does not cure, it does not provide as much support for subsequent layers or adjacent material within the same layer, as normally cured layers would. We have discovered design guidelines that help to maintain the desired model geometries. The clearances listed in Table 1 summarize experimental observations and are referred to by line number. References to X/Y refer to measurements of distance along a vector lying in the X/Y plane. Different solid features are preferably separated by at least 400 μm of liquid in X/Y or 200 μm in Z to remain distinct (lines 1 and 2). Solid features adjacent to liquid are preferably at least 325 thick in X/Y or 200 μm in Z to remain intact (lines 3 & 4). We also observed that features finish larger than designed. This is the case whether or not liquids are being printed, and the typical value is 150 μm normal to the surface; however, when printing with liquids this value increases to 200 μm for surfaces perpendicular (or nearly perpendicular) to the X axis (lines 5 & 6).

Printed rotational joints are a key component of printed robots, but adequate clearance must be provided to ensure that adjacent solids do not fuse while minimizing backlash; we found 300 μm to be an adequate trade-off (line 7). We discovered that introducing a thin shell of support material (by creating voids in the model geometries) that separates the solid from the liquid regions improves build-quality. This layer can be as thin as 200 μm when the layer is nearly perpendicular to the Z axis, but should be at least 500 μm when nearly parallel to the Z axis (lines 8 & 9).

Finally, for certain materials and designs, large contiguous regions of liquid in any particular layer should not exceed 20 mm (line 10), achieved by changing the model geometry or inserting 500 μm diameter support “pillars” (line 11). These support pillars can also be employed to anchor a new layer of solid when printed on top of a liquid layer. Solid features adjacent to large liquid regions should be as thick as possible, particularly in the X direction. For example, the bellows design (FIG. 3) uses 2.11 mm thick solid regions on the layer that contains a 20 mm diameter circle of liquid (line 12).

Designs that adhere to these guidelines should be printable with good results, but minor dimensional changes can have large impacts on the print quality. The most common failure mode occurs when unbonded cured material is swept up by the roller and deposited in the roller bath, clogging the drain that removes liquid. When this occurs, cured and partially cured solidifying material will often be deposited haphazardly over the build area, necessitating cleaning. It is useful for users to become familiar with cleaning the roller bath assembly, the waste area, and the model heads before each print to ensure that the printer is ready to use.

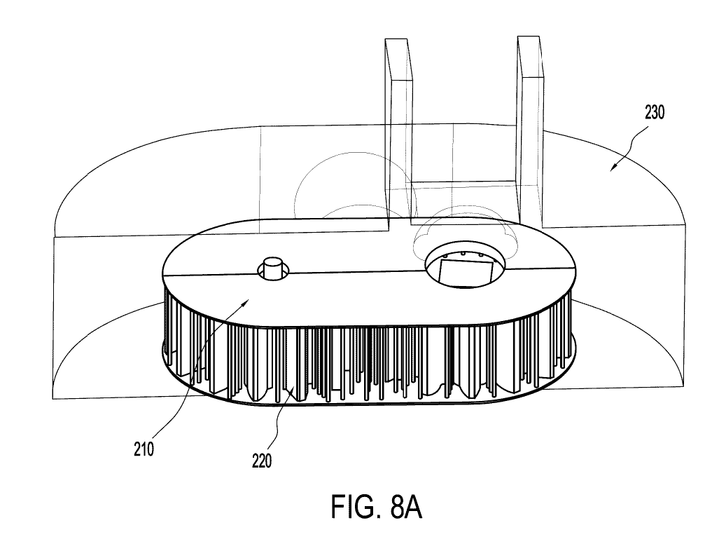

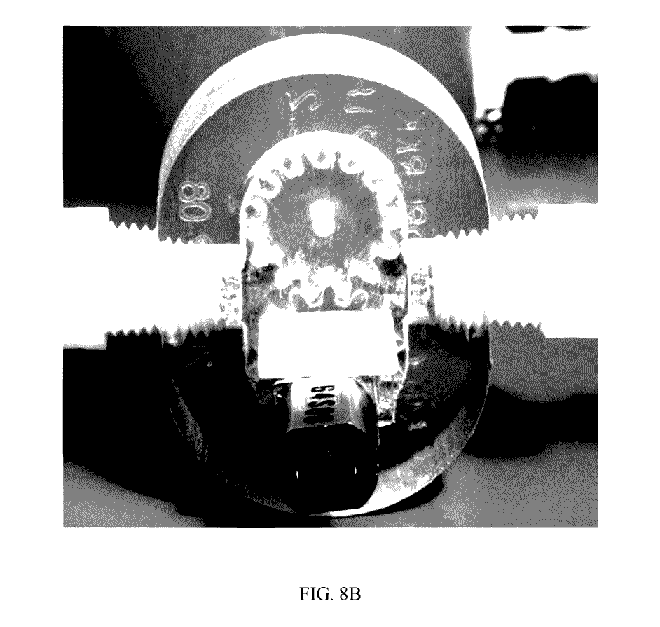

TABLE 1
Design rules when printing with curing and non-curing
materials using a STRATASYS OBJET260 CONNEX 3D printer.
X is aligned along print head scan axis, Z is perpendicular
to build tray, Y follows the right-hand-rule.

| Line | Description | Value | |
|---|---|---|---|
| 1 | Separation (minimum along X/Y-axis) | 0.4 | mm |
| 2 | Separation (minimum along Z-axis) | 0.2 | mm |
| 3 | Feature thickness (minimum along X/Y-axis) | 0.325 | mm |
| 4 | Feature thickness (minimum along Z-axis) | 0.2 | mm |
| 5 | Feature growth (perpendicular to Y/Z-axis) | 0.150 | mm |
| 6 | Feature growth (perpendicular to X-axis) | 0.2 | mm |
| 7 | Solid-solid clearance at rotation joint | 0.3 | mm |
| 8 | Solid-over-liquid support thickness | 0.2 | mm |
| 9 | Solid-next-to-liquid support thickness | 0.5 | mm |
| 10 | Largest segment of liquid (distance in X or Y) | 20 | mm |
| 11 | Recommended width of support “pillars” inserted to | 0.5 | mm |
| | connect model layers otherwise isolated by liquid; | | |
| | see FIG. 8 (X/Y-axis) | | |
| 12 | Recommended solid feature thickness when adjacent | 2.11 | mm |
| | to largest liquid segment (X/Y-axis) | | |

The design rules of Table 1 are experimentally-derived parameters for the particular type of solidifying and non-solidifying materials used (RGD450 and model cleaning fluid, respectively). Thus, the precise values of the design rules may differ depending on the precise nature of the solidifying material. For example, different solidifying and non-solidifying materials may have different surface tension when deposited, which impacts the degree to which the materials will move or spread across a layer.

### Fabricating Robots

The following describes several embodiments that were fabricated according to the techniques described herein. The bellows actuator is a basic force transfer element for printing hydraulic robots, and its use is showcased in a hexapod robot. Also described are a 3D printed fluid gear pump and the use of rubber-like materials to print fluid-actuated soft grippers.

### Bellows Actuator

A U-shaped bellows actuator is an axisymmetric shell convolution, including a plurality of pleats in series; each pleat is a combination of two cut toroidal shells. These U-shaped bellows, also called expansion joints or compensators, are commonly made of metal and are used as compensating elements for thermal expansion and relative movement in pipelines, containers and machines.

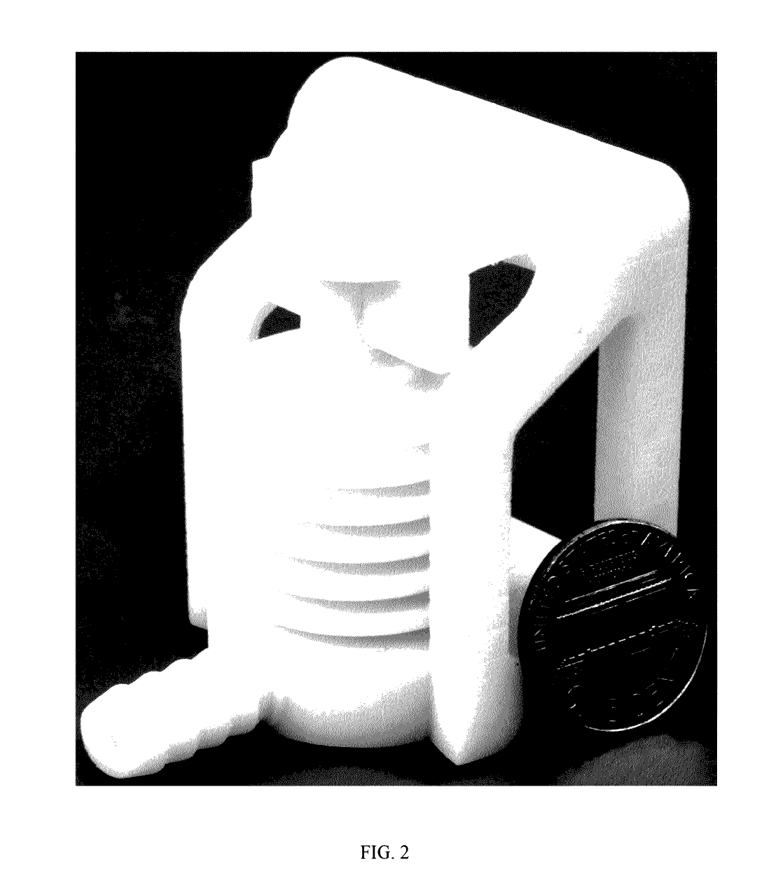

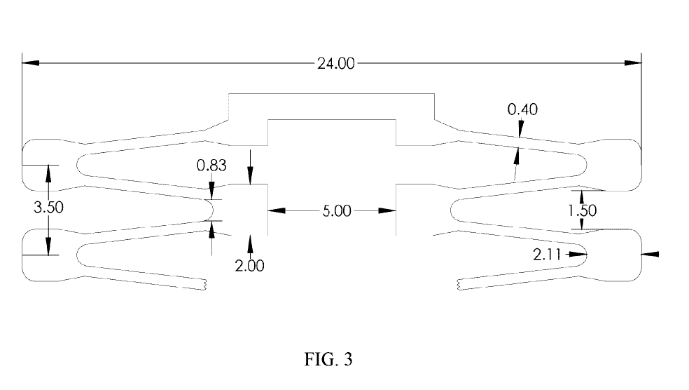

FIG. 2 shows the bellows actuator designed and printed according to the methods described herein. Bellows actuators are more suitable for printed applications than pistons because the latter require sealing tolerances that are difficult to achieve with current 3D printers.

Traditionally, bellows were made of a uniform thickness metal foil. The allowable thickness of this foil depends on several factors, including the working pressure, the desired bellows deformation and the allowable stress in the foil. However, the design rules described in Table 1 imply that a design with a uniform cross-section would need to be so thick that it would be excessively stiff.

FIG. 3 illustrates a bellows with a varying cross-sectional thickness of the solidified material that differs from 0.40 mm to 2.11 mm. The varying cross-sectional thickness necessitated an approach based on finite element analysis (FEA) to optimize the design geometry and anticipate the mechanical behavior of the printed part. Though a closed-form solution would require lower computational effort, there are limitations to finding closed-form solutions for the stress analysis of bellows structures. The simplifications and assumptions required for closed-form solutions are described in Y. Li and S. Sheng, “Strength analysis and structural optimization of U-shaped bellows,” International Journal of Pressure Vessels and Piping, vol. 42, no. 1, pp. 33-46 (1990) and P. Janzen, “Formulae and graphs of elastic stresses for design and analysis of U-shaped bellows,” International Journal of Pressure Vessels and Piping, vol. 7, no. 6, pp. 407-423 (1979). These limitations motivate most bellows designers to use FEA methods.

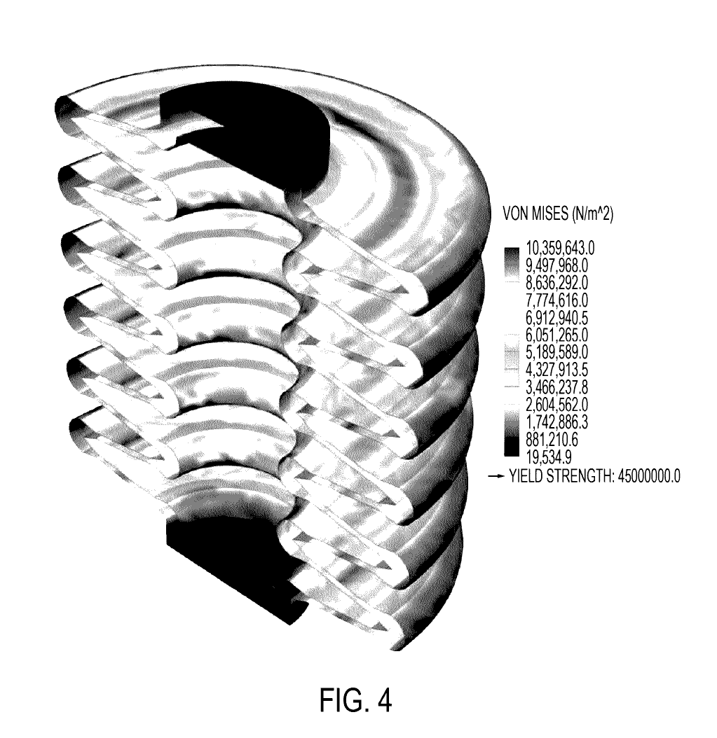

FIG. 4 shows the result of FEA modeling a 2 mm compression of the bellows actuator. FEA was employed using a range of Young's modulus values (900-1200 MPa). This range, which was informed by compression test results, is lower than the manufacturer's stated range (1700-2100 MPa) for the photopolymer we used: Rigur (RGD450) from Stratasys. One possible explanation is that the material undergoes plastic deformation earlier in the strain cycle than expected. Nevertheless, FEA analysis using a linear model is a useful tool for identifying stress concentrations in the part. The geometries of regions that exhibit excessive stress are modified using an iterative homogenization approach in order to reduce stress concentrations, while also adhering to the design guidelines that we experimentally determined and list in Table 1.

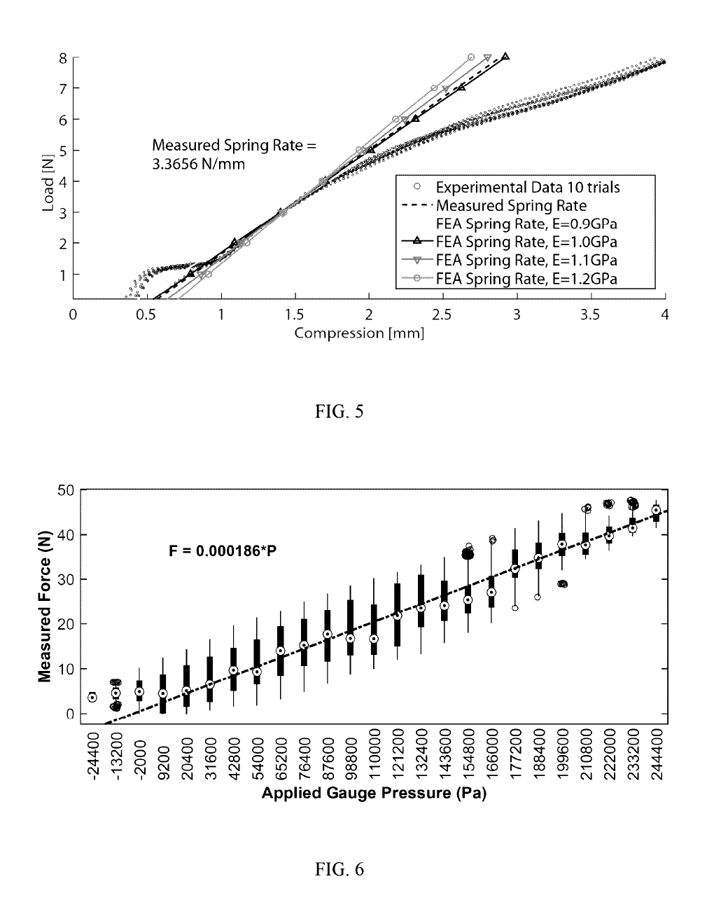

FIG. 5 shows the results of compression tests and the effective spring rates determined via FEA. Compression tests were performed on an Instron 5944 mechanical loading platform, which allowed characterization of the composite stiffness of the bellows design. The spring rate was measured for several printed bellows that were open and had no fluid in them; 3-4 N/mm is typical of our designs. This number is significant from a system design viewpoint, since the fluid pressure driving the bellows must overcome the intrinsic stiffness of the bellows before it can do work on external loads.

FIG. 6 is a graph showing the actual force developed when fluid pressure is applied to a bellows actuator that is allowed to move in response to varying pressure. Tests were carried out at five operating load set points, and the actuator was allowed to extend and contract as a cyclic pressure activation was applied. A least-squares fit of the pressure vs. force data yield a trend line with a slope of 186 mm², which is the effective cross-sectional area of the bellows actuator if the bellows were modeled as a piston. This number is 60% of the actual internal area of the bellows cap shown in FIG. 2 and depicted schematically in FIG. 3. The actuator exhibits hysteresis, likely due to friction at the rotary joints, visible as deviations from the linear trend line. The results reveal that a hysteresis loop is formed as the bellows is pressure-cycled.

### Hexapod Robot

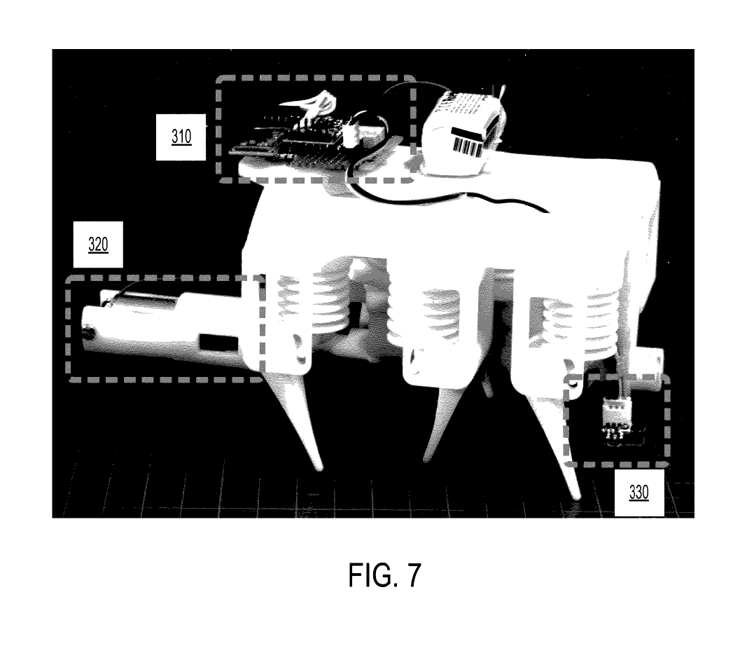

To demonstrate the utility of the printed bellows design in an actual robot, a tripod-gait hexapod with six rotational degrees of freedom (DOF), which is illustrated in FIGS. 1 and 7, was designed. With the exception of the DC motor and power supply, all components of this robot are printed in a single printing operation with no assembly required. This robot weighs 690 g, is 14 cm long, 9 cm wide, and 7 cm tall. The legs are designed with a neutral position that inclines their major axis 60 degrees above the floor and each leg is actuated by a bellows, causing the leg to rotate 10 degrees in either direction, relative to this neutral position. Three of the legs are inclined toward the front of the robot (bank A) and three are inclined toward the rear (bank B).

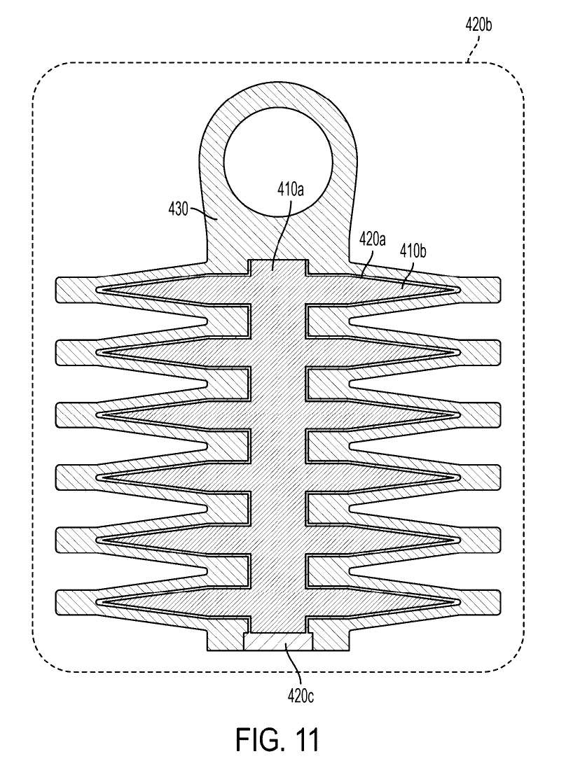

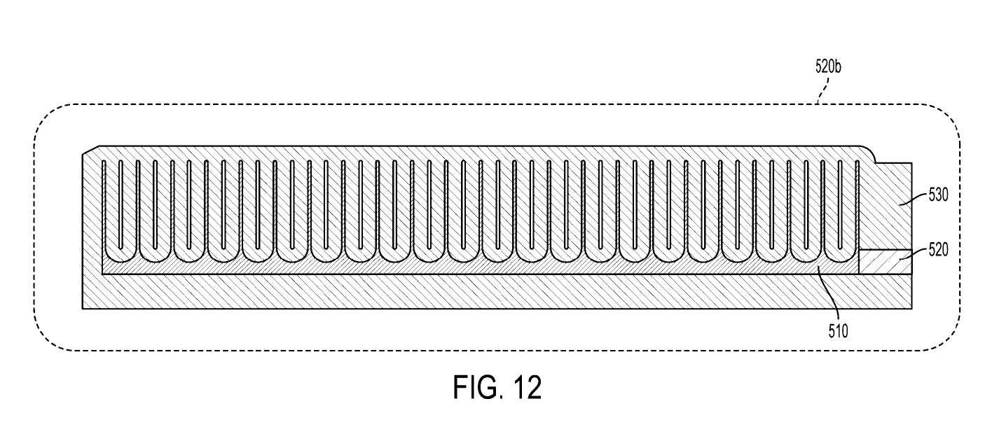

FIG. 11 is a schematic showing a cross-section of a 3D-print pattern for a bellows portion of a hexapod robot according to an embodiment of the invention. The cross-section is shown along the Z/X plane, and the bellows portion attaches to an assembly for the robot. As printed, the bellows portion has non-solidifying (e.g., liquid) material (410a and 410b), support material (420a, 420b, and 420c), and solidifying material 430. The support material 420b supports the bellows as is it 3D printed, and the support material 420b is typically removed in a post-processing step, which can include washing or other manual removal process. The support material (420a and 420c) is not typically removed in a post-processing step. The support material (420a, 420b, and 420c) can be, for example Model Support Material supplied by Stratasys Ltd., Eden Prairie, Minn., USA. The Model Support Material can be a photopolymerizing acrylate. Upon solidifying, solidified material (420a, 420b, and 420c) is typically weaker than solidified material 430 in the sense that extent of elongation before failure and tear strength are lower. Upon completing of the 3D printing operation, the bellows portion of the hexapod robot includes the non-solidifying material (410a and 410b), solidifying material (420a, 420b, and 420c), and solidifying material 430. Non-solidifying material forms a primary channel 410a and a secondary channel 410b. The support material 420c forms a plug, which isolates the non-solidifying material (410a and 410b) and prevents it from flowing out of the bellows. Upon compression of the bellows, such as by activation of a motor (not shown), the plug typically fails or breaks, thereby allowing fluid flow into a connecting channel (not shown). Including a plug 420c also permits improved print quality, thereby improving force transfer, and reducing the likelihood of print errors.

FIG. 7 is a photograph of a hexapod robot. The robot uses a tripod gait. A single DC motor spins a central crankshaft that pumps fluid via banks of bellows pumps directly above the crankshaft. Fluid is forced out of the pumps and distributed to each leg actuator by pipes embedded within the robot's body. An onboard microcontroller 310 controls a motor 320, enabling responses to environmental stimuli via a sensor 330 and control from a cellphone via Bluetooth (not shown).

Each driven bellows is internally connected to a corresponding driving bellows via a fluid channel that runs through the robot's body; the fluid in each driving/driven bellows pair is isolated from the other bellows. The three driving bellows from bank A are kinematically linked and attached to a crankshaft via a connecting rod. The bellows from bank B are similarly connected to a separate section of the crankshaft that is 90° out of phase. The crankshaft is turned at 30 RPM by a single geared DC motor consuming approximately 2 W (Pololu Item #3070, Pololu Corporation, Las Vegas, Nev., USA), yielding a locomotion speed of 0.125 body-lengths per second. This arrangement moves the legs from the two banks 90° out of phase with each other, enabling forward or backward locomotion without an additional DOF at each leg, and does not require the feet to slide on the floor. Though this gait is determined by the mechanical design, behaviors can be added using a robot compiler developed in previous work. See A. Mehta, J. DelPreto, and D. Rus, “Integrated codesign of printable robots,” Journal of Mechanisms and Robotics, vol. 7, no. 2, p. 021015 (2015); see also A. M. Mehta, J. DelPreto, B. Shaya, and D. Rus, “Cogeneration of mechanical, electrical, and software designs for printable robots from structural specifications,” in Intelligent Robots and Systems (IROS 2014), 2014 IEEE/RSJ International Conference on. IEEE, 2014, pp. 2892-2897. The robot compiler encapsulates low-level implementation details within functional blocks that allow desired behaviors to be composed; the compiler's output includes control software that can be loaded directly onto the robot's controller.

### Gear Pump

Gear pumps are low-flow, high-pressure devices, that are commonly employed in hydraulic systems and are capable of producing continuous flow. We designed and printed a gear pump to present an alternative to the bellows pump, which produces only reciprocating flow. The general design approach for gear pumps is well known and their internal pressure transients and performance have been described elsewhere. These pumps employ a pair of enmeshed counter-rotating teeth enclosed in a tight-fitting housing. Fluid trapped between the teeth and the housing is moved from the low-pressure port to the high pressure port, and is prevented from moving back by the meshed teeth near the center of the pump.

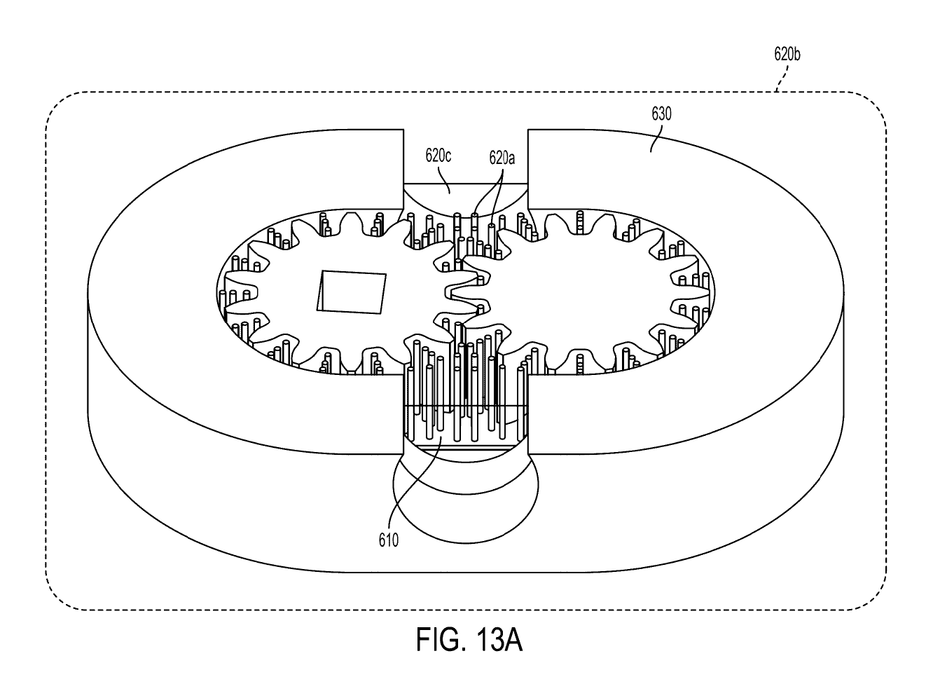

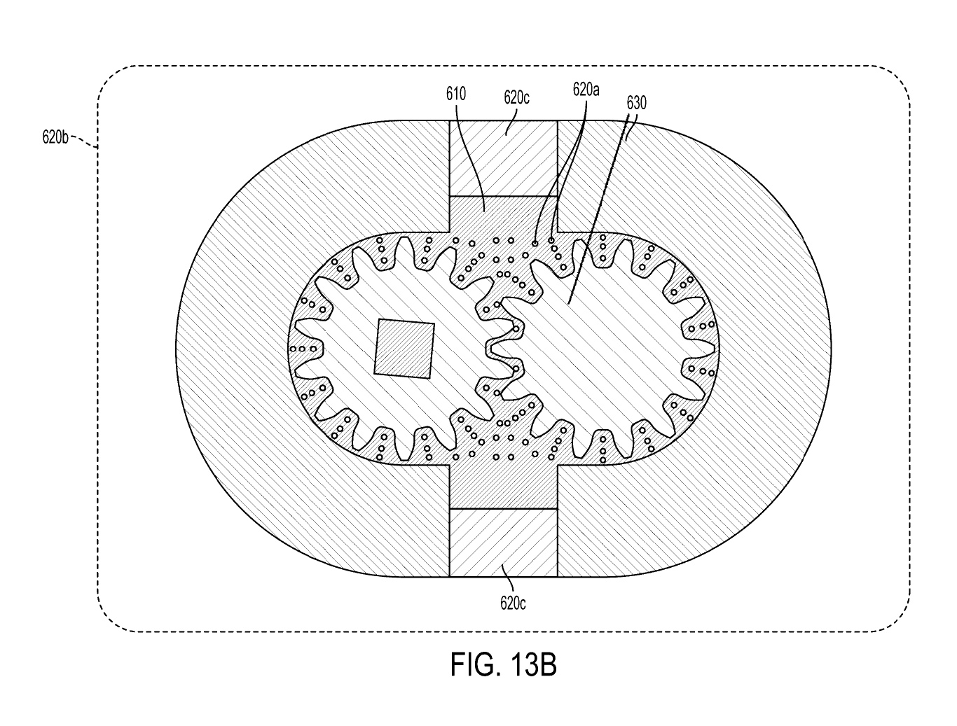

FIGS. 13A-B are schematics showing a perspective view (FIG. 13A) and a cross-section (FIG. 13B) of a 3D-print pattern for a gear pump according to an embodiment of the present invention. The cross-section of FIG. 13B is shown along the X/Y plane. As printed, the gear pump has non-solidifying (e.g., liquid) material 610, support material (620a and 620b), and solidifying material 630. The support material 620a forms vertical columns that support the structure as it is printed, by providing anchors for the eventual deposition (in subsequent print layers) of the “cap” of the pump's internal volume. The vertical columns of support material 620a also provide temporary “baffles” within the non-solidifying material, which reduce the amount that the non-solidifying material moves (“sloshes”) within the printed structure during normal vibrations that are a consequence of the printing process. The support material 620c forms plugs, similar to the plug that is formed in the bellows portion of the robot leg. Upon activation of the gear pump by a motor, liquid flows through the gears, causing the support pillars 620a and plugs 620c to fail and wash away. The support material 620b supports the gear pump as it is 3D printed, and the support material 620b is typically removed in post-processing steps, as described with respect to the bellows portion of the robot leg. Support material (620a, 620b, and 620c) can be formed of Model Support Material from Stratasys Ltd. In the perspective view of FIG. 13A, only one of the plugs 620c is shown in order to improve clarity.

FIG. 8A is a section view of the pump prototype that reveals the two meshed gears and their position within the housing. The gears have a pitch diameter of 17.5 mm, an outer diameter of 19.6 mm, a modulus of 1.25, and a gear height of 8 mm. We followed the common practice of using involute gears with a 20° pressure angle.

Like the bellows, the design of the gear pump was informed by the design rules listed in Table 1. The gears are surrounded by a thin liquid layer that separates the gears from the housing's interior walls. The liquid clearance is 200 The pump design includes flat layers of rigid material that are directly above a layer of liquid, with no connection to another solid portion of the pump. This situation is problematic, leading to increased position uncertainty and the possibility that the roller will entirely remove new solid layers as they are deposited. The solution is to add arrays of small (e.g., 500 μm diameter) support pillars 620a aligned along the Z axis that penetrate the liquid layer, providing an anchor for the new layer of solid while still being fragile enough to easily break down when the pump's gears are rotated. Thin (e.g., 200 μm) regions of support directly below solid layers that would otherwise rest on liquid were also added. This improves the surface finish of the solid layer. FIG. 8A depicts these support regions 210, the gears 220, and the housing 230. The liquid layer is not shown, but occupies the remaining negative space.

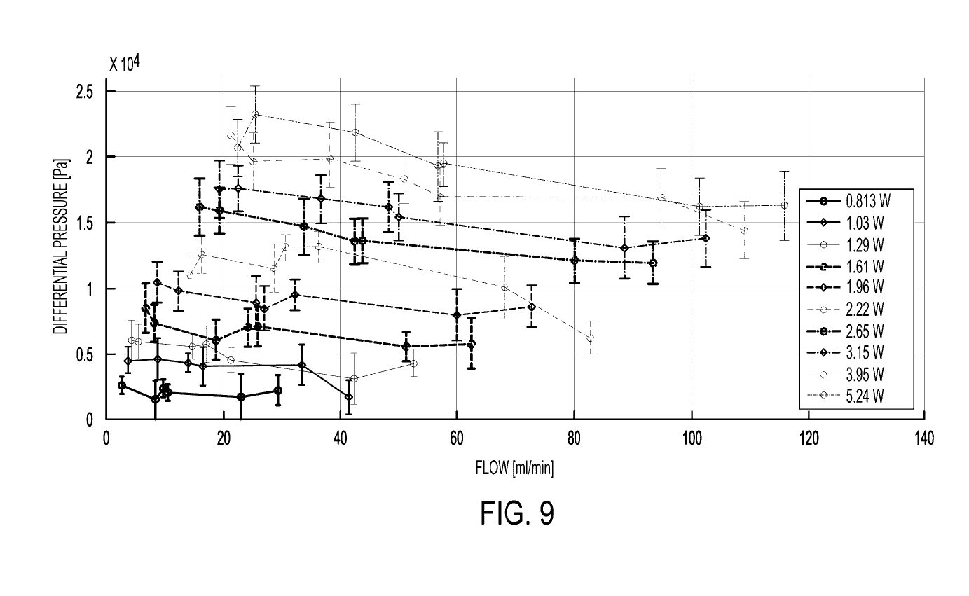

FIG. 9 is a graph of differential pressure output (Pa) vs. Flow rate (ml/min) for a variety of applied power (W) for a 3D-printed gear pump. Pump performance was evaluated by measuring the pressure drop across a valve versus flow for different input power levels and valve positions. The test was performed using a small off-the-shelf brushed DC motor with a 250:1 gear ratio and a D-shaped output shaft that was inserted into one of the pump's gears.

### Soft Gripper

The emerging field of Soft Robotics offers a compelling alternative to traditional rigid-bodied robots, enabling structures that deform continuously, are robust, and are safer for human interaction. Soft robots present the designer with a complex, continuous feature space; designers have employed modular design approaches and evolutionary search to address this challenge, yielding body plans with complex geometries that are challenging to build with conventional methods. Soft robots also present unique actuation difficulties; embedded tensile elements (cables or shape memory alloy (SMA)), and pneumatics are widely employed, though often at the cost of fabrication complexity.

Soft robots are usually fabricated via cast elastomers, and although casting soft robots is often faster than assembling conventional rigid robots, the mold-making process can be time consuming, and embedding multiple materials within a cast object via overmolding adds complexity. Additionally, producing complex, graded materials via casting is difficult. Additive manufacturing, combined with the printed hydraulics approach, provides an alternative fabrication method for soft robotics that is automated, flexible, and enables geometries that are infeasible with other production methods.

FIG. 12 is a schematic showing a cross-section of a 3D-print pattern for a soft gripper according to an embodiment of the present invention. The cross-section is shown along the Z/X plane. As printed, the gripper has non-solidifying (e.g., liquid) material 510, support material (520, 520b), and solidifying material 530. Support material 520 forms a plug. Upon compression of the working fluid (non-solidifying material), such as by activation of a motor or pump (not shown), the plug 520 typically fails or breaks. Support material 520b supports the gripper as is it 3D printed, and the support material 520b is typically removed in a post-processing step, which can include washing or other manual removal process.

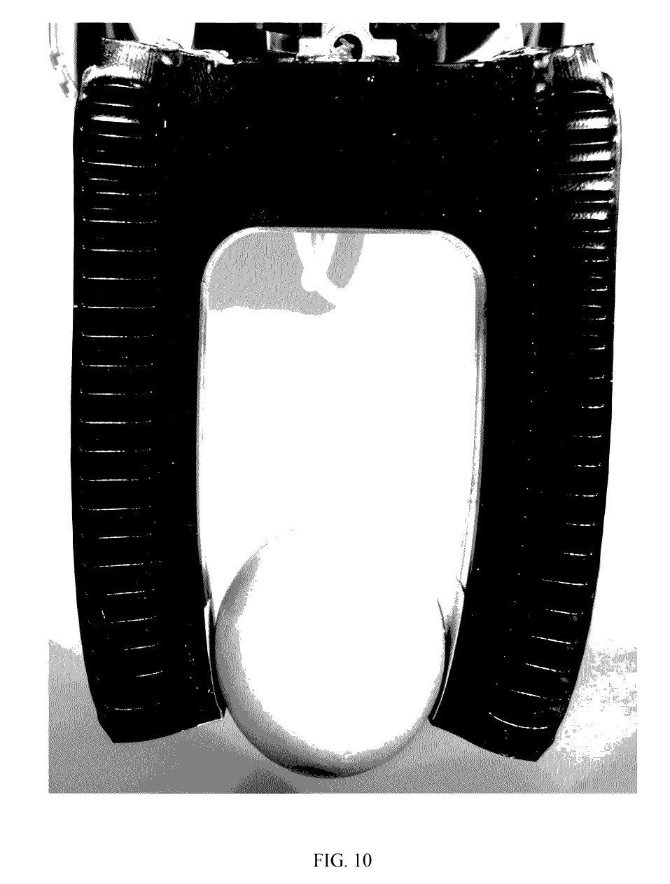

FIG. 10 is a photograph of a 3D-printed two finger soft gripper. The design process required four iterations. Each iteration required 3.5 hours to print and a short time to evaluate the performance of the part. This method is faster and more automated than soft-robot fabrication approaches that rely on casting materials into molds. For the soft gripper, the solidifying material is TANGO BLACK PLUS (Stratasys Ltd., Eden Prairie, Minn., USA), which is a soft, “rubbery” material. After curing (solidifying) the TANGO BLACK PLUS material has a lower elastic modulus (e.g., is more flexible), such that an equivalent force deflects the cured TANGO BLACK PLUS material more than the cured RGD450 material. As a result, a “finger” made from TANGO BLACK PLUS material can displace more that if made with the RGD450 material. However the TANGO BLACK PLUS material is more prone to tearing, particularly if deflected to high degree. Additionally, the final gripper design incorporates thin channels and internal fluid routing that would be difficult to achieve via casting.

### CONCLUSIONS

Building robots inevitably involves the time-consuming and labor-intensive operation of assembling a large number of discrete pieces. 3D printers offer a way forward: by increasing the functionality of each part and fabricating ready-to-use assemblies of many parts, manual assembly steps can be reduced or eliminated. Disclosed herein are robust, high-performance force-transmission elements incorporated directly into a 3D-printed part. Though individual hydraulic components have previously been fabricated via 3D printing, non-trivial post-processing steps including cleaning and assembly have always been required. Instead, our printed hydraulics method incorporates liquids directly into the designer's material palette, enabling complex, functional, multi-part robotic assemblies that use hydraulic force transmission to be automatically fabricated, obviating the need for assembly.

Though printable hydraulics offers a rich design space for automatically fabricating ready-to-use, potentially disposable robots, the material and process limitations of current multi-material 3D printers sacrifice properties like mechanical strength, maximum elongation, fatigue lifetime and part resolution, relative to more specialized fabrication approaches. However, for many applications these disadvantages will be outweighed by the ability to automatically and rapidly fabricate entire robotic structures with force transmission elements embedded directly within the robot's body.

### EQUIVALENTS

While this invention has been particularly shown and described with references to example embodiments thereof, it will be understood by those skilled in the art that various changes in form and details may be made therein without departing from the scope of the invention encompassed by the appended claims.

What is claimed is:

1. A method of forming a structure, the method comprising:
a) depositing layers of a solidifying material and a non-solidifying material, the depositing forming a volume defined by the solidifying material and containing the non-solidifying material within the volume, the depositing being capable of depositing the solidifying and non-solidifying materials at substantially each layer while forming the volume; and
b) encapsulating the non-solidifying material within the volume by depositing the solidifying material in a manner that forms a continuous, interior surface of the solidifying material to seal the volume, thereby forming the structure.

2. The method of claim 1, further comprising solidifying the solidifying material.

3. The method of claim 1, wherein the non-solidifying material is deposited as a liquid.

4. The method of claim 1, wherein depositing layers further comprises depositing a support material at given locations, and the method further comprises removing the support material during or after solidifying the solidifying material.

5. The method of claim 4, wherein the support material is deposited to prevent flow of the non-solidifying material.

6. The method of claim 1, wherein the interior surface is seamless.

7. The method of claim 1, wherein one or more of the solidifying material, non-solidifying material, and support material is an additive manufacturing material.

8. The method of claim 1, wherein depositing the solidifying material includes forming a deformable structure, defined by the solidifying material, configured to deform at least a portion of the volume in response to a mechanical force.

9. The method of claim 1, wherein the structure has a plurality of deformable pleats.

10. The method of claim 9, wherein the pleats have varying cross-sectional thickness.

11. The method of claim 1, wherein the structure has enmeshed counter-rotating teeth.

12. The method of claim 1, wherein depositing is performed by a print head.

13. The method of claim 12, wherein the print head includes a roller, and wherein the method further comprises applying the roller to a surface of the solidifying material to smooth the surface of the solidifying material.

14. The method of claim 12, wherein the method further comprises raising the roller above a portion of a surface of the non-solidifying material so that the roller does not remove the portion of the surface of the non-solidifying material.

15. The method of claim 1, wherein depositing layers is performed by first depositing the solidifying material and then depositing the non-solidifying material.

16. The method of claim 1, wherein solidifying comprises exposing the solidifying material to light.

17. The method of claim 1, wherein solidifying comprises cooling the solidifying material.

18. The method of claim 1, wherein depositing the layers includes forming a channel in at least a portion of the volume, the non-solidifying material filling at least a portion of the channel.

19. The method of claim 18, wherein the channel is oriented horizontal, vertical, or any angle therebetween, relative to the layers.

20. The method of claim 18, wherein the solidifying material is deposited to form a perimeter of the channel and the non-solidifying material is deposited in a manner that underfills the channel while forming the channel.

21. The method of claim 20, further comprising filling an underfilled channel with the non-solidifying material prior to encapsulating the non-solidifying material.

22. The method of claim 18, wherein the channel has a varying cross-sectional area along a portion of the channel.

23. The method of claim 1, the depositing further comprises depositing a second solidifying material.

24. The method of claim 1, wherein the solidifying materials have different elastic moduli after solidifying.

25. A deformable structure defining a volume, the structure comprising a continuous interior surface of solidified material that encapsulates a non-solidified material within the volume, the structure being deformable in response to a mechanical force.

26. The deformable structure of claim 25, wherein mechanical properties of the structure differ at different locations of the structure.

27. The deformable structure of claim 25, wherein the inner surface is seamless.

28. The deformable structure of claim 25, wherein one or more of the solidifying material and the non-solidifying material are additive manufacturing materials.

29. The deformable structure of claim 25, wherein the deformable structure further comprises an internal channel having the non-solidified material therein.

30. The deformable structure of claim 29, wherein the structure defines an exterior surface, wherein at least a portion of the exterior and interior surfaces are deformable, and wherein applying a force to the deformable exterior surface causes the interior surface to deform and, in turn, causes the volume to deform and force an amount of the non-solidified material to flow through the channel.

31. The deformable structure of claim 30, wherein the deformable exterior and interior surfaces define a plurality of deformable pleats in fluid communication with the channel, and wherein deformation of the pleats causes flow of the non-solidified material to flow along the channel.

32. The deformable structure of claim 25, wherein the deformable structure comprises a second solidified material.

33. The deformable structure of claim 32, wherein the solidified materials have different elastic moduli.
